(19) United States
(12) Patent Application Publication
(10) Pub. No.: US 2013/0069538 A1
(43) Pub. Date: Mar. 21, 2013

(54) AUTOMATIC AND MANUAL DIMMING METHOD AND APPARATUS THEREOF

(71) Applicant: YU-SHENG SO, New Taipei City (TW)

(72) Inventor: YU-SHENG SO, New Taipei City (TW)

(21) Appl. No.: 13/237,959

(22) Filed: Sep. 21, 2011

(51) Int. Cl. H05B 37/02

(52) U.S. Cl. 315/152

(57) ABSTRACT

The present invention discloses an automatic and manual dimming method and an apparatus thereof, comprising a plurality of LED lamps with a light sensor and a control unit, such that when a power switch is turned on to trigger the control unit to automatically adjust the light emitting brightness of the LED lamp according to the brightness of the light sensed by the light sensor. After one or more times of switching the power switch, the control unit can be used for manually adjusting the light emitting brightness of the LED lamp to improve the convenience of use.

### FIELD OF THE INVENTION

The present invention relates to an automatic and manual dimming method and an apparatus thereof, in particular to the automatic and manual dimming method and apparatus capable of adjusting the light of a plurality of LED lamps immediately and automatically after the LED lamps are turned on or adjusting the light of the LED lamps manually.

### BACKGROUND OF THE INVENTION

In general, traditional fluorescent tube does not have a dimming capability, and causes a waste of energy source by providing illumination for indoor space that does not require a high brightness or failing to make an appropriate adjustment for a too-bright condition, so that the traditional fluorescent tube usually cannot meet the energy-saving and environmental protection requirements.

Most present LED lamps are manufactured into tube type LED lamps and bulb type LED lamps and used extensively for indoor illuminations. In addition, a LED lamp dimming method and an apparatus thereof are introduced for the use as the illumination of an indoor space that does not require a very bright condition.

However, the dimming apparatus usually having a relatively large volume is installed outside the original circuit and device of the LED lamp, and it is necessary to change the original circuit of the LED lamp, thus incurring higher installation and construction costs, and affecting the external appearance of the LED lamp, and the dimming method requires the aforementioned apparatus to dim the LED lamp. Obviously, the conventional LED lamp requires further improvements.

### SUMMARY OF THE INVENTION

Therefore, it is a primary objective of the present invention is to overcome the shortcomings of the prior art by providing a smart method of automatically dimming a lamp immediately after the lamp is turned on, and manually dimming the lamp anytime, and an apparatus that can be installed easily to carry out the aforementioned method, so as to avoid affecting a user's vision and meet the power saving and environmental protection requirements. In addition, the method of the present invention can use the original circuit and device of the LED lamp to improve the convenience of use.

To achieve the aforementioned objective, the present invention provides an automatic and manual dimming method, comprising the following steps:

Turn on a power switch to trigger a control unit to drive an LED lamp, and the control unit automatically adjusts the light emitting brightness of the LED lamp according to the light brightness sensed by a light sensor installed on the LED lamp.

The control unit continues detecting the number of times of switching the power switch, and a switch of the power switch is defined as a motion of turning off the power switch once and continuing turning on the power switch.

When the control unit detects one switch of the power switch, the control unit progressively changes a light emitting brightness of the LED lamp, or stops changing the light emitting brightness of the LED lamp.

When the control unit detects two successive switches of the power switch, the control unit reverses the order of progressively changing the light emitting brightness of the LED lamp.

When the control unit detects two or more successive switches of the power switch, the control unit adjusts the light emitting brightness of the LED lamp automatically according to the brightness of the light sensed by the light sensor.

The dimming method of the present invention is illustrated by a preferred embodiment as follows.

The control unit, LED lamp and the light sensor come with a plural quantity, and receive electric power from the power switch.

The control unit is capable of adjusting the light emitting brightness of the LED lamp in a slow varying manner.

The LED lamp progressively changes the light emitting brightness and stops changing the light emitting brightness at the brightest or darkest condition.

When the control unit detects one switch of the power switch, and the LED lamp has not changed the light emitting brightness progressively, the light emitting brightness of the LED lamp is changed progressively. When the control unit detects one switch of the power switch, and the LED lamp changes the light emitting brightness progressively, the control unit stops changing the light emitting brightness of the LED lamp.

When the control unit detects two or more successive switches of the power switch, and the LED lamp has not stopped changing the light emitting brightness, the control unit reverses the order of changing the light emitting brightness of the LED lamp progressively.

The control unit progressively keeps changing the light emitting brightness of the LED lamp such that the light emitting brightness could be from dark to light and from light to dark repeatedly.

The LED lamp comes with a plural quantity, and when the LED lamp starts changing the light emitting brightness progressively, the control unit presets the light emitting brightness of the LED lamp to the brightest or darkest condition, or the control unit presets the light emitting brightness of the LED lamp to the brightness of the previously turned-off LED lamp.

In addition, the present invention provides an automatic and manual dimming apparatus comprising: a plurality of LED lamps embedded on a wall; one or more light sensors, installed on the LED lamp or an edge of the LED lamp; at least one control unit, respectively and electrically coupled to the LED lamp and the light sensor; and a power switch, electrically coupled between the control unit and a power supply, and the power switch being turned on to trigger the control unit to adjust the light emitting brightness of the LED lamp automatically according to the brightness of the light sensed by the light sensor, when the power switch is switched successively for one time or more than one time, the control unit then adjusts the light emitting brightness of the LED lamp manually, and the switch of the power switch being defined a motion of turning off the power switch once and continuing turning on the power switch.

The dimming apparatus of the present invention is described by a preferred embodiment as follows:

The LED lamp has a light color and a color temperature different from each other.

The LED lamp includes a transparent lamp cover, and a positioning hole formed on the transparent lamp cover and provided for installing the light sensor therein; or LED lamp includes a casing, and a positioning hole formed on the casing and provided for installing the light sensor therein; or the LED lamp includes a lamp frame, and a positioning hole formed on the lamp frame and provided for installing the light sensor therein. Wherein, the transparent lamp cover can also be semi-transparent lamp cover to ensure the light scattered into the light sensor evenly.

The LED lamp includes a casing, and a ring sheathed on the external periphery of the casing, and the light sensor is installed onto the ring, wherein the ring includes at least one positioning hole formed on an external wall of the ring, and the light sensor is installed in the positioning hole, or the ring includes a circular groove formed on an external wall of the ring, and the light sensor is slidably installed in the circular groove.

The positioning hole includes a sticker disposed at an external periphery of the positioning hole for blocking a portion of light projected onto the light sensor; or the positioning hole includes a sticker disposed at an external periphery of the positioning hole for blocking a portion of light projected onto the light sensor, and the shading element includes a transparent window corresponding to the positioning hole. The relative position of the window and the positioning hole can be adjusted to control the openness of the positioning hole through the window to the outside.

The light sensor includes a sensing portion and a positioning portion formed on both ends of the light sensor respectively, and the positioning portion is fixed onto the LED lamp, and a pivotal portion is disposed between the sensing portion and the positioning portion and capable of swinging in a direction towards one or more axes.

Compared with the prior art, the present invention has the following advantages:

1. The smart lamp can be dimmed automatically and immediately after the lamp is turned on, or the light can be adjusted manually anytime to improve the convenience of use while achieving the power saving effect.

2. A single power switch can be used for synchronously controlling a plurality of LED lamps, and the operation is user-friendly, simple and convenient.

3. Each LED lamp can adjust its own brightness according to its position, so that the light everywhere is adjusted uniformly to achieve the ideal brightness for many locations in an indoor space.

4. When the brightness of the plurality of LED lamps is adjusted, the initial brightness of each LED lamp can be uniform to facilitate adjusting the brightness of the LED lamps to the most appropriate brightness within a short time.

5. The control unit and the light sensor can be built in the original LED lamp available in the market, so that no additional work or components such as a control box, a modified power switch and an electric wire is required. The installation procedure can be simplified, and the external wiring can be waived to comply with the environmental protection requirements.

6. The sensing direction of the light sensor can be changed freely to improve the sensitivity of sensing the brightness of the light and achieve the most appropriate brightness of the LED lamp.

### BRIEF DESCRIPTION OF THE DRAWINGS

FIG. 1 is a flow chart of an automatic and manual dimming method in accordance with a preferred embodiment of the present invention;

FIG. 2 is a flow chart of an additional method of the preferred embodiment as depicted in FIG. 1;

FIG. 3 is a schematic block diagram of a configuration in accordance with a preferred embodiment of the present invention;

FIG. 4 is a perspective view of a bulb type LED lamp in accordance with the present invention;

FIG. 5 is a perspective view of an embedded LED lamp in accordance with the present invention;

FIG. 6 is a perspective view of a tube type LED lamp in accordance with the present invention;

FIG. 7 is a perspective view of another embedded LED lamp in accordance with the present invention;

FIG. 8 is a perspective view of a further embedded LED lamp in accordance with the present invention;

FIG. 9 is a perspective view of another bulb type LED lamp in accordance with the present invention;

FIG. 10 is a cross-sectional view of a ring as depicted in FIG. 9;

FIG. 11 is a perspective view of a further bulb type LED lamp in accordance with the present invention;

FIG. 12 is a cross-sectional view of an additional implementation configuration of the preferred embodiment as depicted in FIG. 5;

FIG. 13 is a cross-sectional view of an additional implementation configuration of the preferred embodiment as depicted in FIG. 10;

FIG. 14 is a cross-sectional view of another additional implementation configuration of the preferred embodiment as depicted in FIG. 5;

FIG. 15 is a cross-sectional view of a further additional implementation configuration of the preferred embodiment as depicted in FIG. 5;

FIG. 16 is a bottom view of a plug tube as depicted in FIG. 15;

FIG. 17 is a partial perspective view of an additional implementation configuration of the preferred embodiment as depicted in FIG. 6; and

FIG. 18 is a partial perspective view of another additional implementation configuration of the preferred embodiment as depicted in FIG. 6.

### DESCRIPTION OF THE PREFERRED EMBODIMENTS

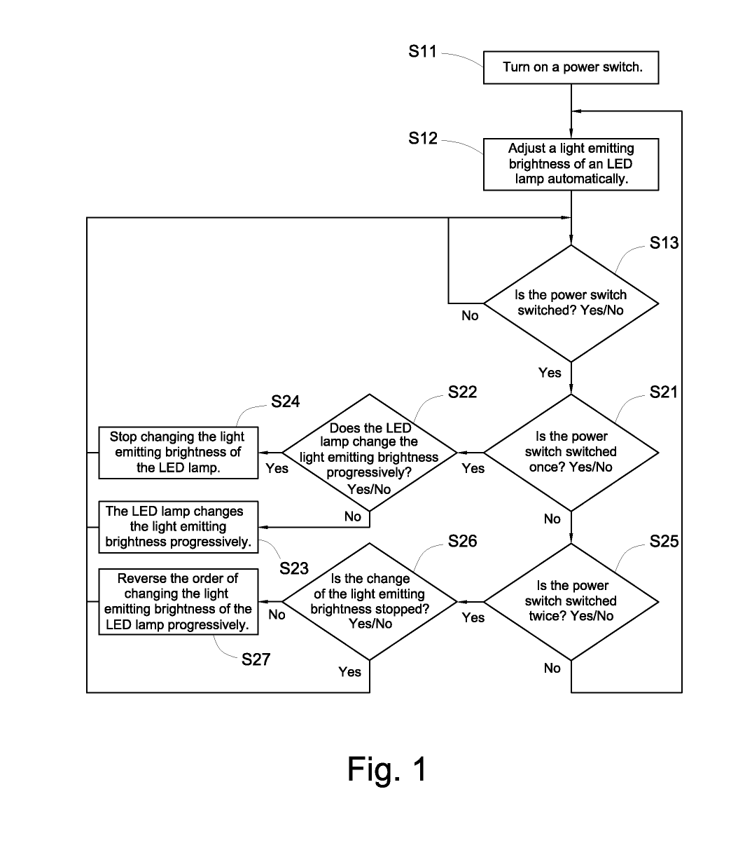

With reference to FIG. 1 for a flow chart of an automatic and manual dimming method in accordance with a preferred embodiment of the present invention and FIG. 3 for the description of the dimming method of the present invention, the dimming method comprises the following steps:

S11: Turn on a power switch 1 to trigger a control unit 2 to enter into an automatic dimming mode and drive an LED lamp 3, and automatic dimming mode of the control unit 2 has a plurality of default light emitting brightness parameters, and the light emitting brightness parameters refer to the difference between a default light emitting brightness and a brightness of an actual environment before the LED lamp 3 is turned on.

S12: The control unit 2 compares the brightness in an environment sensed by a light sensor 4 installed on the LED lamp 3 to produce a set of light emitting brightness parameters, and adjusts the light emitting brightness of the LED lamp 3 automatically according to the set of light emitting brightness parameter, so that users can feel the soft, comfortable and ideal light emitting brightness of the LED lamp 3, and the modules including the control unit 2, the LED lamp 3 and the light sensor 4 are combined and assembled to produce a dimming lamp set 30. In this preferred embodiment, the control unit 2, LED lamp 3 and light sensor 4 can come with a plural quantity, and the quantity of the control units 2 is equal to the quantity of the LED lamps 3, so that the control units 2, LED lamps 3 and light sensors 4 can form a plurality of dimming lamp sets 30, 30a, 30b, 30c that receive electric power from the single power switch 1.

S13: While the control unit 2 is adjusting the light emitting brightness of the LED lamp 3 automatically, the control unit 2 detects whether or not a user switches the power switch 1, and the number of times of switching the power switch 1 made by the user, and continues the detection if the user has not switched the power switch 1. A switch of the power switch 1 is defined as a motion of turning off the LED lamp 3 once, and keeping turning on the power switch 1.

S21: When the control unit 2 detects that the user switches the power switch 1, the control unit 2 detects whether or not the user has switched the power switch 1 once.

S22: If the control unit detects that the user switches the power switch 1 once, the control unit 2 will enter into a manual dimming mode, so that the control unit 2 will detect whether or not the LED lamp 3 changes the light emitting brightness progressively.

S23: If the control unit detects that the LED lamp does not change the light emitting brightness progressively, the control unit 2 will change the light emitting brightness of the LED lamp 3 from dark to bright or from bright to dark progressively, and then the step S13 will be repeated.

S24: If the control unit 2 detects that the user switches the power switch 1 once again in the step S21, and detects that the LED lamp 3 changes the light emitting brightness progressively in the step S22, the control unit 2 will stop changing the light emitting brightness of the LED lamp 3, and then the step S13 will be repeated.

S25: If the control unit 2 detects that the user switches the power switch 1 for more than one time in the step S21, the control unit 2 will detect whether or not the user switches the power switch 1 for a second time. If the control unit detects that the user switches the power switch 1 successively for more than two times, the control unit 2 will enter into the automatic dimming mode again, so that the control unit 2 will adjust the light emitting brightness of the LED lamp 3 automatically according to the brightness of the light sensed by the light sensor 4.

S26: If the control unit 2 detects that the user switches the power switch 1 successively for two times, the control unit 2 will detect whether or not the LED lamp 3 has stopped changing the light emitting brightness. If the control unit 2 detects that the LED lamp 3 has stopped changing the light emitting brightness, the control unit 2 will repeat the step S13.

S27: If the control unit 2 detects that the LED lamp 3 has not stopped changing the light emitting brightness, the control unit 2 will reverse the order of changing the light emitting brightness of the LED lamp 3 progressively, and the step S13 will be repeated.

From the description above, a single power switch 1 can be used for controlling the dimming lamp sets 30, 30a, 30b, 30c synchronously. If the control unit 2 or the LED lamp 3 of any one of the dimming lamp sets 30, 30a, 30b, 30c is damaged, the control unit 2 and the LED lamp 3 of the other dimming lamp sets 30, 30a, 30b, 30c will not be affected, and the LED lamp 3 of each dimming lamp set 30, 30a, 30b, 30c can have its own light adjustment made by the control unit 2.

The dimming method of the present invention is described by a preferred embodiment as follows.

In Step S12, the control unit 2 can adjust and change the light emitting brightness of the LED lamp 3 slowly to prevent the light sensor 4 from being interfered by external objects such as shadows or lights and avoid adjusting the light emitting brightness of the LED lamp 3 frequently by the control unit 2 or affecting the user's vision.

In Steps S23 and S27, the LED lamp 3 can change the light emitting brightness from dark to bright or from bright to dark progressively and stop changing the light emitting brightness at the brightest or darkest condition to prevent continuous changes of the light emitting brightness and avoid causing troubles of use.

In Step S23, if the LED lamp 3 starts changing the light emitting brightness from dark to bright or from bright to dark progressively, the control unit 2 presets the light emitting brightness of the LED lamp 3 to the brightest or darkest condition; or the control unit 2 presets the light emitting brightness of the LED lamp 3 to the brightness of the previously turned-off LED lamp 3, so that the same initial brightness of the LED lamp 3 can be achieved, under the condition of having many lamps and not control lines.

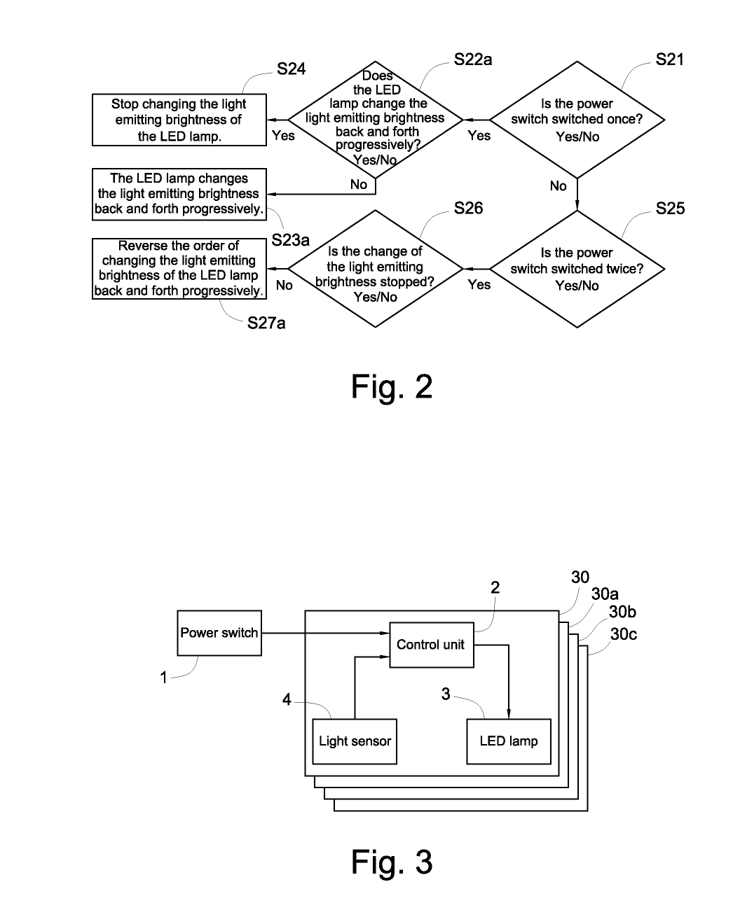

With reference to FIG. 2 or the steps S23a and S27a, the control unit 2 can keep changing the light emitting brightness of LED lamp 3 from dark to bright and then from bright to dark progressively. In the step S22a, the control unit 2 detects whether or not the LED lamp 3 changes the light emitting brightness from dark to bright and then from bright to dark progressively.

With reference to FIG. 3 for a schematic block diagram of a configuration in accordance with a preferred embodiment of the present invention, the dimming apparatus of the invention comprises a plurality of LED lamps 3 embedded into a wall, one or more light sensors 4, at least one control unit 2 and a power switch 1.

The LED lamps 3 can be embedded into a ceiling or a wall of a building, and the light sensors 4 are installed to each of the LED lamps 3 or an edge of the LED lamps 3 respectively.

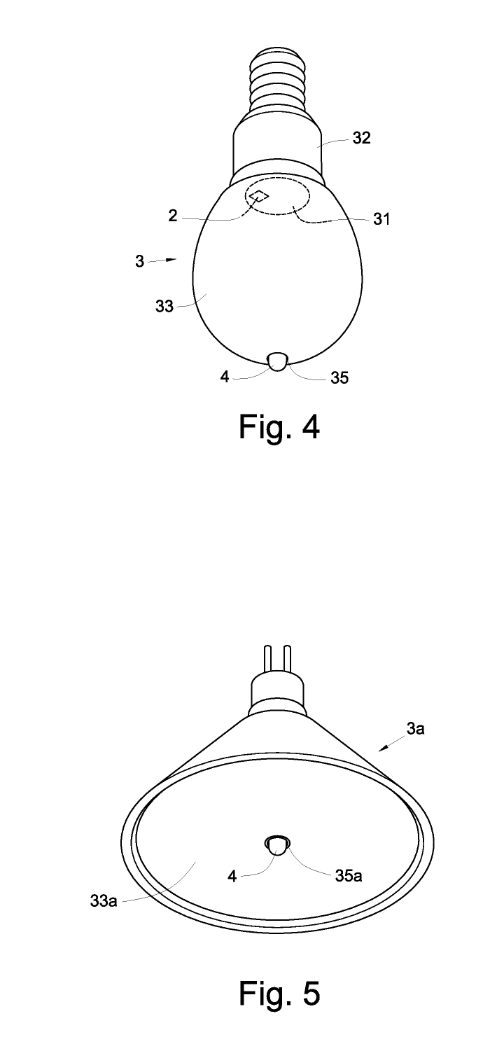

The LED lamp 3 includes a casing 32 and a transparent lamp cover 33 interconnected with each other (as shown in FIG. 4), and the LED lamp 3 is disposed in the transparent lamp cover 33, and the light sensor 4 is disposed on the transparent lamp cover 33.

The casing 32 includes a driving unit 31 of the LED lamp 3 and electrically coupled to the LED lamp 3, and the control unit 2 comprises a detection circuit and a logic circuit, and the control unit 2 can be modularized and assembled to the driving unit 31, and the control unit 2 is electrically coupled to the LED lamp 3 and the light sensor 4, so that the control unit 2, the LED lamp 3 and the light sensor 4 can form a plurality of dimming lamp sets 30, 30a, 30b, 30c.

The power switch 1 can be embedded into a wall of a building, and the power switch 1 is electrically coupled between the control unit 2 and an indoor AC power supply by using the original power supply circuit of the building.

Therefore, the single power switch 1 can be turned on or switched to drive the control unit 2 and the light sensor 4 of the dimming lamp sets 30, 30a, 30b, 30c synchronously, so as to control the LED lamps 3 of the dimming lamp sets 30, 30a, 30b, 30c synchronously to carry out the dimming method of the present invention.

Since the power consumption of the LED lamp 3 is approximately half of that of the traditional fluorescent lamps, therefore the single power switch 1 can be turned on to start the control unit 2, and the control unit 2 can be used for driving each of the LED lamps 3. When use, the control unit 2 can adjust the light emitting brightness of the LED lamp 3 automatically according to the brightness of the light sensed by the light sensor 4, and the power switch 1 can be used to adjust the light emitting brightness of the LED lamp 3 manually anytime.

The dimming apparatus of the present invention is illustrated by a preferred embodiment as follows:

When implemented, the LED lamp 3 can be embedded into a wall or a ceiling of a building, or embedded into an external side wall of a storage cabin or any downwardly aligned wall.

When implemented, the light color and the color temperature of the LED lamp 3 can be different to provide diversified indoor lighting configurations.

When implemented, the LED lamps 3, 3a can be bulb-type or embedded LED lamps (as shown in FIG. 5), and each of the transparent lamp covers 33, 33a include a downwardly aligned positioning hole 35, 35a, and the light sensor 4 is installed in the positioning hole 35, 35a.

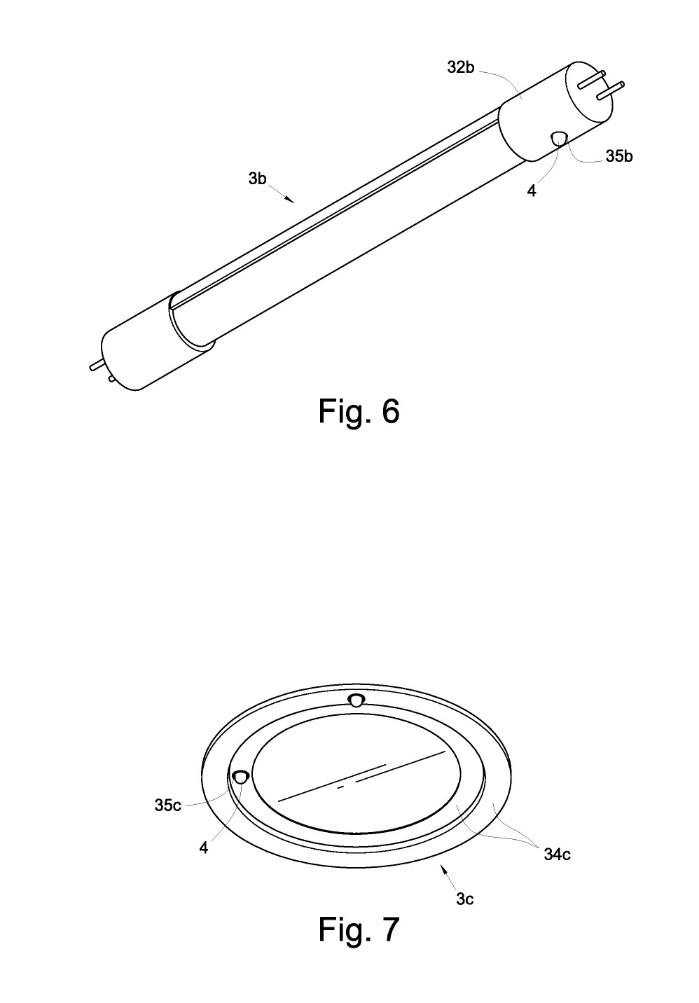

When implemented, the LED lamp 3b can be a tube-type LED lamp (as shown in FIG. 6), and the LED lamp 3b has a downwardly aligned positioning hole 35b formed on a side of the casing 32b, and the light sensor 4 is installed in the positioning hole 35b.

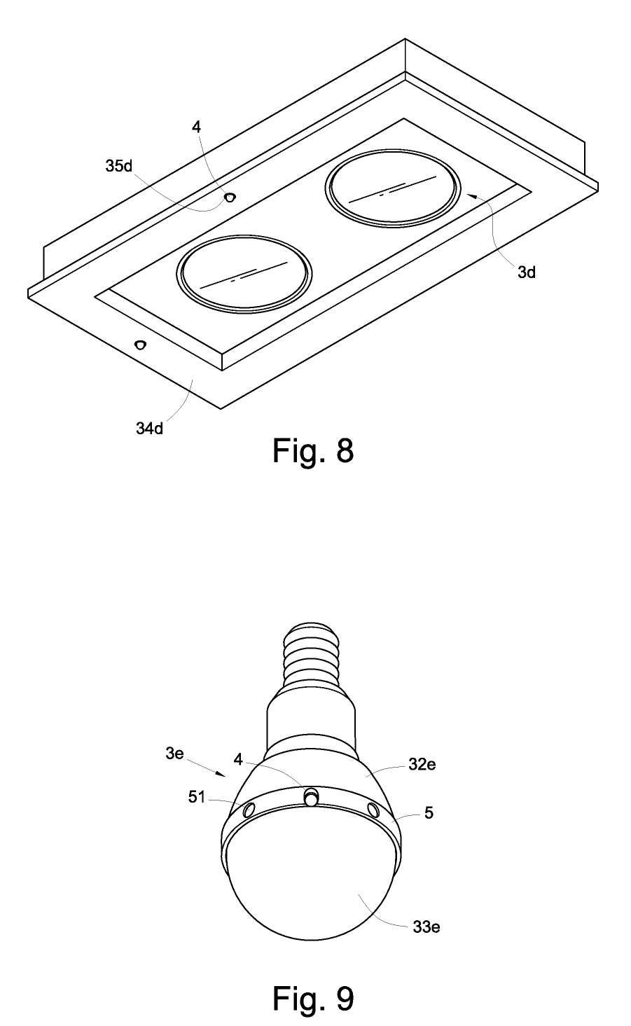

When implemented, each of the LED lamps 3c, 3d is embedded into a lamp frame 34c, 34d in a circular shape, a rectangular shape or any other shape (as shown in FIGS. 7 and 8), and the lamp frame 34c, 34d includes one or more downwardly aligned positioning holes 35c, 35d, and the light sensor 4 is installed in the positioning hole 35c, 35d, and the light sensors 4, and the positioning holes 35c, 35d can be arranged with an included angle of 90 degrees by using the LED lamp 3c, 3d as the center. Such arrangement facilitates users to adjust the installation positions of the light sensors 4 according to the actual environment where the LED lamps 3c, 3d are installed.

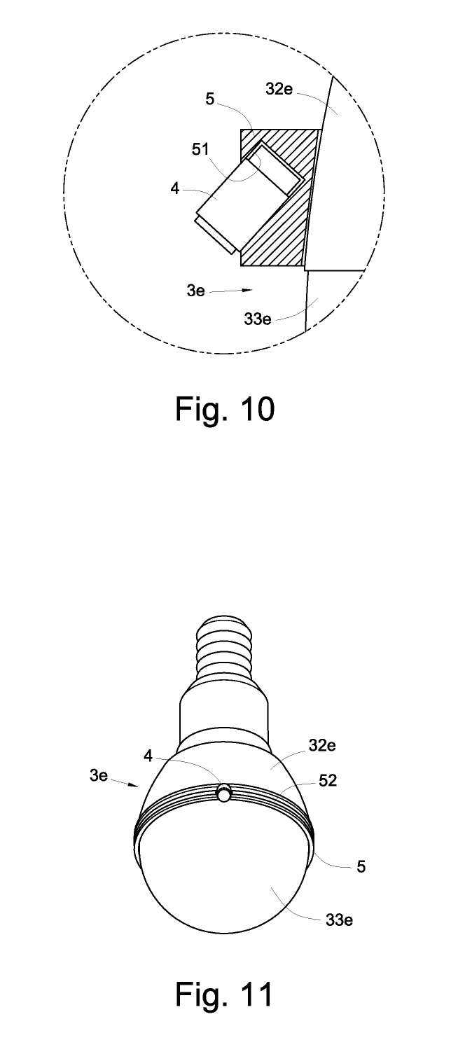

When implemented, the casing 32e and the transparent lamp cover 33e of the LED lamp 3e are coupled into bulb type LED lamp, and a ring 5 can be sheathed on the external periphery of the casing 32e (as shown in FIG. 9), and the ring 5 is proximate to the transparent lamp cover 33e, and the light sensor 4 can be installed slantingly onto the ring 5 and in the illumination direction of the LED lamp 3e. In fact, the light sensor 4 can be installed slantingly downward.

Wherein, the ring 5 includes at least one positioning hole 51 formed on an external wall of the ring 5 and tilted in the illuminating direction of the LED lamp 3e (as shown in FIG. 10), and the light sensor 4 is installed in the positioning hole 51, or the ring 5 has a circular groove 52 formed on an external wall of the ring 5 (as shown in FIG. 11), and the light sensor 4 is slidably installed in the circular groove 52, so as to simplify the structure and facilitate the installation.

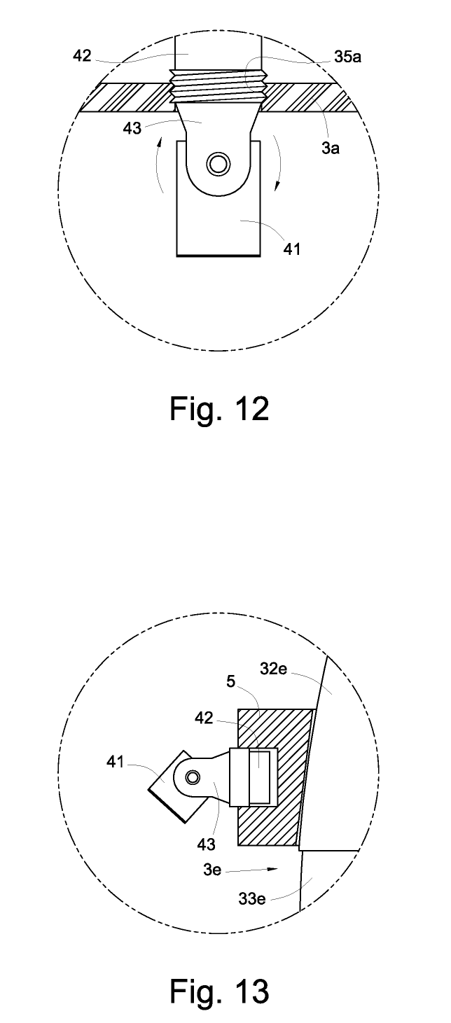

When implemented, the light sensor 4 includes a sensing portion 41 (as shown in FIGS. 12 and 13) and a positioning portion 42 disposed at both ends of the light sensor 4 respectively, and the positioning portion 42 is fixed to the LED lamp 3a, 3e, and a pivotal portion 43 is disposed between the sensing portion 41 and the positioning portion 42 and can be swung in a direction towards one or more axes. With the pivotal portion 43, the sensing portion 41 can be adjusted and tilted towards the illumination direction of the LED lamp 3a, 3e.

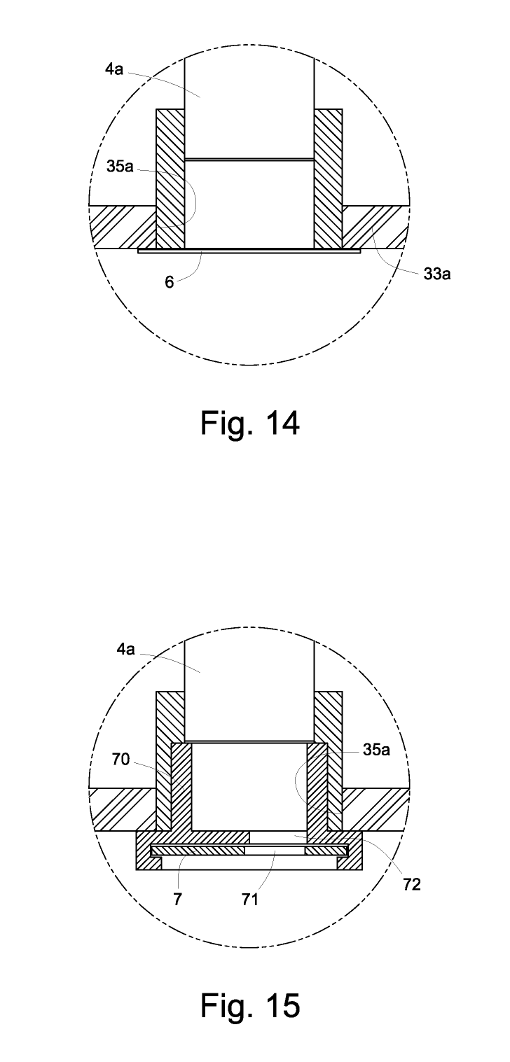

When implemented, the light sensor 4a can be installed in the positioning hole 35a (as shown in FIG. 14), and a semi-transparent sticker 6 is stuck on a surface of the transparent lamp cover 33a at the external periphery of the positioning hole 35a for blocking a portion of light projected onto the light sensor 4a to adjust the sensitivity of sensing light by the light sensor 4a.

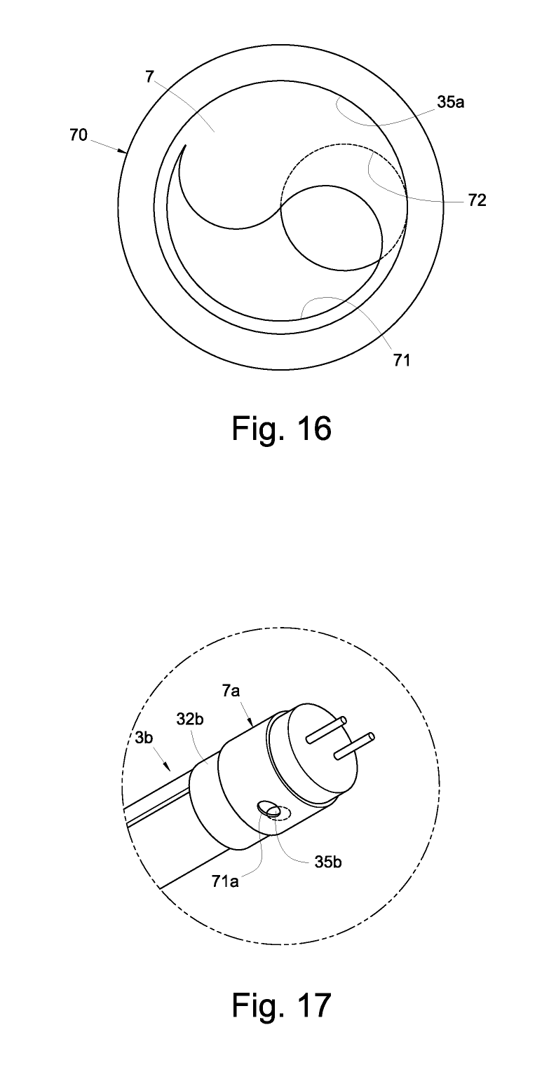

When implemented, the positioning hole 35a includes a shading element 7 movably installed at an external periphery of the positioning hole 35a and capable of opening or closing the positioning hole 35a (as shown in FIGS. 15 and 16), and the shading element 7 has a transparent window 71 corresponding to the positioning hole 35a.

When implemented, the positioning hole 35a includes a plug tube 70 installed therein, and the plug tube 70 includes an opening 72 interconnected to the positioning hole 35a, and the shading element 7 is substantially in a disc shape, and the internal wall of the bottom of the plug tube 70 can restrict the shading element 7 from turning at a corresponding end of the opening 72, so that the relative positions of the window 71 and the opening 72 of the shading element 7 can be adjusted to adjust the relative positions of the window 71 and the positioning hole 35a, so as to control the openness of the positioning hole 35a through the opening 72 and the window 71 to the outside, and block a portion of light projected onto the light sensor 4a, and adjust the sensitivity of receiving light by the light sensor 4a.

When implemented, the shading element 7a can be in a tubular shape (as shown in FIG. 17), and the shading element 7a is sheathed on the casing 32b on a side of the tube type LED lamp 3b for sheltering the positioning hole 35b of the casing 32b. The shading element 7a an be turned to adjust the relative positions of the window 71a and the positioning hole 35b to control the openness of the positioning hole 35b through the window 71a to the outside, so as to block some of the light projected onto the light sensor.

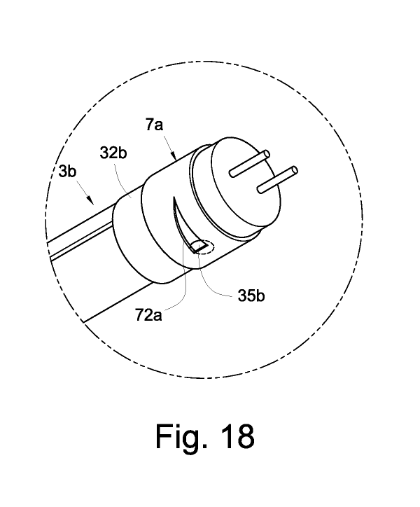

When implemented, the windows 71, 71a, 72a can be in a circular shape, a strip shape or a triangular shape (as shown in FIG. 18).

Compare with the prior art, the present invention definitely has the following advantages:

1. The smart lamp can be dimmed automatically and immediately after the lamp is turned on, or the light can be adjusted manually anytime to improve the convenience of use while achieving the power saving effect.

2. A single power switch can be used for synchronously controlling a plurality of LED lamps, and the operation is user-friendly, simple and convenient.

3. Each LED lamp can adjust its own brightness according to its position, so that the light everywhere is adjusted uniformly to achieve the ideal brightness for many locations in an indoor space.

4. When the brightness of the plurality of LED lamps is adjusted, the initial brightness of each LED lamp can be uniform to facilitate adjusting the brightness of the LED lamps to the most appropriate brightness within a short time .

5. The control unit and the light sensor can be built in the original LED lamp available in the market, so that no additional work or components such as a control box, a modified power switch and an electric wire is required. The installation procedure can be simplified, and the external wiring can be waived to comply with the environmental protection requirements.

6. The sensing direction of the light sensor can be changed freely to improve the sensitivity of sensing the brightness of the light and achieve the most appropriate brightness of the LED lamp.

What is claimed is:

1. An automatic and manual dimming method, comprising the steps of:
turning on a power switch to trigger a control unit to drive an LED lamp, and the control unit automatically adjusting a light emitting brightness of the LED lamp according to a light brightness sensed by a light sensor installed to the LED lamp;
the control unit continuously detecting the number of times of switching the power switch, wherein a switch of the power switch is defined as a motion of turning off the power switch once and keeping turning on the power switch; and
driving the control unit to change a light emitting brightness of the LED lamp progressively, or stop changing the light emitting brightness of the LED lamp, when the control unit detects one switch of the power switch.

2. The automatic and manual dimming method of claim 1, further comprising the steps of:
reversing the order of changing the light emitting brightness of the LED lamp progressively by the control unit, when the control unit detects two successive switches of the power switch; and
adjusting the light emitting brightness of the LED lamp automatically by the control unit according to the brightness of the light sensed by the light sensor, when the control unit detects more than two successive switches of the power switch.

3. The automatic and manual dimming method of claim 2, wherein the control unit reverses the order of changing the light emitting brightness of the LED lamp progressively when two successive switches of the power switch are detected, and the LED lamp has not stopped changing the light emitting brightness.

4. The automatic and manual dimming method of claim 1, wherein the control unit, the LED lamp and the light sensor come with a plural quantity and receive an electric power supplied by the power switch.

5. The automatic and manual dimming method of claim 1, wherein the control unit automatically adjusting the light emitting brightness of the LED lamp in a slow varying manner.

6. The automatic and manual dimming method of claim 1, wherein the LED lamp progressively changes the light emitting brightness and stops at the brightest or darkest condition.

7. The automatic and manual dimming method of claim 1, wherein the LED lamp progressively changes the light emitting brightness when the control unit detects one switch of the power switch, and the LED lamp has not progressively changed the light emitting brightness.

8. The automatic and manual dimming method of claim 1, further comprising the step of stopping changing the of the light emitting brightness of the LED lamp, when the control unit detects one switch of the power switch, and the LED lamp progressively changes the light emitting brightness.

9. The automatic and manual dimming method of claim 1, wherein the control unit continues changing the light emitting brightness of the LED lamp progressively from dark to light and from light to dark repeatedly.

10. The automatic and manual dimming method of claim 1, wherein the LED lamp comes with a plural quantity, and when the LED lamp starts changing the light emitting brightness progressively, the control unit presets the light emitting brightness of the LED lamp to the brightest or darkest condition.

11. The automatic and manual dimming method of claim 1, wherein the LED lamp come with a plural quantity, and when the LED lamp starts changing the light emitting brightness progressively, the control unit presets the light emitting brightness of the LED lamp to the brightness of the previously turned-off LED lamp.

12. An automatic and manual dimming apparatus, comprising:
a plurality of LED lamps embedded on a wall;
one or more light sensors, installed on the LED lamp or an edge of the LED lamp;
at least one control unit, respectively and electrically coupled to the LED lamp and the light sensor; and
a power switch, electrically coupled between the control unit and a power supply, and the power switch being turned on to trigger the control unit to adjust the light emitting brightness of the LED lamp automatically according to the brightness of the light sensed by the light sensor; when the power switch is switched successively for one time or more than one time, the control unit then adjusts the light emitting brightness of the LED lamp manually, and the switch of the power switch being defined a motion of turning off the power switch once and continuing turning on the power switch.

13. The automatic and manual dimming apparatus of claim 12, wherein the LED lamp has a light color and a color temperature different from each other.

14. The automatic and manual dimming apparatus of claim 12, wherein the LED lamp includes a transparent lamp cover or a semi-transparent lamp cover, and a positioning hole formed on the transparent lamp cover and provided for installing the light sensor therein.

15. The automatic and manual dimming apparatus of claim 12, wherein the LED lamp includes a casing, and a positioning hole formed on the casing and provided for installing the light sensor therein.

16. The automatic and manual dimming apparatus of claim 12, wherein the LED lamp includes a lamp frame, and a positioning hole formed on the lamp frame and provided for installing the light sensor therein.

17. The automatic and manual dimming apparatus of claim 12, wherein the LED lamp includes a casing, and a ring sheathed on the external periphery of the casing, and the light sensor is installed onto the ring.

18. The automatic and manual dimming apparatus of claim 17, wherein the ring includes at least one positioning hole formed on an external wall of the ring, and the light sensor is installed in the positioning hole.

19. The automatic and manual dimming apparatus of claim 17, wherein the ring includes a circular groove formed on an external wall of the ring, and the light sensor is slidably installed in the circular groove.

20. The automatic and manual dimming apparatus of claim 14, wherein the positioning hole includes a sticker disposed at an external periphery of the positioning hole for blocking a portion of light projected onto the light sensor.

21. The automatic and manual dimming apparatus of claim 15, wherein the positioning hole includes a sticker disposed at an external periphery of the positioning hole for blocking a portion of light projected onto the light sensor.

22. The automatic and manual dimming apparatus of claim 16, wherein the positioning hole includes a sticker disposed at an external periphery of the positioning hole for blocking a portion of light projected onto the light sensor.

23. The automatic and manual dimming apparatus of claim 18, wherein the positioning hole includes a sticker disposed at an external periphery of the positioning hole for blocking a portion of light projected onto the light sensor.

24. The automatic and manual dimming apparatus of claim 14, wherein the positioning hole includes a shading element movably installed at an external periphery of the positioning hole and capable of opening or closing the positioning hole.

25. The automatic and manual dimming apparatus of claim 24, wherein the shading element includes a transparent window corresponding to the positioning hole.

26. The automatic and manual dimming apparatus of claim 15, wherein the positioning hole includes a shading element movably installed at an external periphery of the positioning hole and capable of opening or closing the positioning hole.

27. The automatic and manual dimming apparatus of claim 26, wherein the positioning hole includes a shading element movably installed at an external periphery of the positioning hole and capable of opening or closing the positioning hole.

28. The automatic and manual dimming apparatus of claim 16, wherein the positioning hole includes a shading element movably installed at an external periphery of the positioning hole and capable of opening or closing the positioning hole.

29. The automatic and manual dimming apparatus of claim 28, wherein the shading element includes a transparent window corresponding to the positioning hole.

30. The automatic and manual dimming apparatus of claim 18, wherein the positioning hole includes a shading element movably installed at an external periphery of the positioning hole and capable of opening or closing the positioning hole.

31. The automatic and manual dimming apparatus of claim 30, wherein the shading element includes a transparent window corresponding to the positioning hole.

32. The automatic and manual dimming apparatus of claim 12, wherein the light sensor includes a sensing portion and a positioning portion formed on both ends of the light sensor respectively, and the positioning portion is fixed onto the LED lamp, and a pivotal portion is disposed between the sensing portion and the positioning portion and capable of swinging in a direction towards one or more axes.
